(19) United States
(12) Patent Application Publication
(10) Pub. No.: US 2007/0151097 A1
(43) Pub. Date: Jul. 5, 2007

(54) Assembling system

(76) Inventor: Dimitri Philippou, Milnerton (ZA)

Correspondence Address: STITES & HARBISON PLLC, 1199 NORTH FAIRFAX STREET, SUITE 900, ALEXANDRIA, VA, 22314, US

(21) Appl. No.: 10/549,808

(22) PCT Filed: Mar. 18, 2004
(86) PCT No.: PCT/IB04/50279

§ 371 Date: Dec. 4, 2006

(30) Foreign Application Priority Data
Mar. 19, 2003 (ZA) 2003/2148

(51) Int. Cl. B23P 19/00

(52) U.S. Cl. 29/700

(57) ABSTRACT

The invention discloses an assembling system, which includes at least one transmission means for transmitting signals and/or sub-atomic and/or atomic particles and/or impulses of energy; at least one input means for providing signals and/or sub-atomic and/or atomic particles and/or impulses of energy to be transmitted to the transmission means; and at least one output means having at least one molecular and/or sub-atomic and/or impulses of energy assembling means adapted to receive the signals and/or the sub-atomic and/or atomic particles and/or impulses of energy from the transmission means and capable of molecular and/or sub-atomic and/or impulses of energy manufacturing of at least one object defined by the signals and/or sub-atomic and/or atomic particles and/or impulses of energy.

### FIELD OF INVENTION

The present invention relates to assembling systems.

More particularly, the present invention relates to assembling systems for assembling molecules.

### BACKGROUND TO INVENTION

Nanotechnology is defined as the engineering of matter at a scale approaching that of individual atoms, i.e. the branch of technology that deals with dimensions and tolerances of less than 100 nanometres, especially the manipulation of individual atoms and molecules. Developments in the field of nanotechnology enable novel practical applications thereof.

It is an object of the invention to suggest a novel assembling system.

### SUMMARY OF INVENTION

According to the invention, an assembling system includes
(a) at least one transmission means for transmitting signals;
(b) at least one input means for providing signals to be transmitted to the transmission means; and
(c) at least one output means having molecular and/or sub-atomic and/or impulses of energy assembling means adapted to receive the signals from the transmission means and capable of molecular and/or sub-atomic manufacturing of an object defined by the signals.

Also, according to the invention, a method for manufacturing an object, includes the steps
(a) of providing signals to be transmitted to at least one transmission means;
(b) of transmitting the signals transmitted to the transmission means to at least one output means having at least one molecular and/or sub-atomic and/or impulses of energy assembling means; and
(c) of molecular and/or sub-atomic and/or impulses of energy manufacturing an object defined by the signals received by the molecular and/or sub-atomic and/or impulses of energy assembling means from the transmission means.

Yet further according to the invention, an assembling system includes
(a) at least one transmission means for transmitting sub-atomic and/or atomic particles and/or impulses of energy;
(b) at least one input means for providing the sub-atomic and/or atomic particles and/or impulses of energy to be transmitted to the transmission means; and
(c) at least one output means having at least one molecular and/or sub-atomic and/or impulses of energy assembling means adapted to receive the sub-atomic and/or atomic particles and/or impulses of energy from the transmission means and capable of molecular and/or sub-atomic and/or impulses of energy manufacturing of an object defined by the sub-atomic and/or atomic particles and/or impulses of energy.

Also, according to the invention, a method for manufacturing an object, includes the steps
(a) of providing sub-atomic and/or atomic particles and/or impulses of energy to be transmitted to at least one transmission means;
(b) of transmitting the sub-atomic and/or atomic particles and/or impulses of energy transmitted to the transmission means to at least one output means having at least one molecular and/or sub-atomic and/or impulses of energy assembling means; and
(c) of manufacturing an object defined by the sub-atomic and/or atomic particles and/or impulses of energy received by the molecular and/or sub-atomic and/or impulses of energy assembling means from the transmission means.

The input means may include at least one molecular or sub-atomic and/or impulses of energy disassembling means adapted to take apart structures, and recording structural information at each step.

The molecular and/or sub-atomic and/or impulses of energy disassembling means may be automated.

The molecular and/or sub-atomic and/or impulses of energy assembling means may be automated.

The object(s) may be at least three-dimensional and/or a hologram.

The assembling means and/or disassembling means may utilise nanotechnology and/or thermal imaging.

The object(s) may be in different time periods, different parallel worlds and/or different time quadrants in relation to each other and the input means.

The transmission means may be adapted to transport and/or convey molecules and/or atoms and/or sub-atomic particles and/or impulses of energy associated with the signals.

The object manufactured by the molecular and/or sub-atomic manufacturing means may be a replica or an original of a structure disassembled by the molecular and/or sub-atomic and/or impulses of energy disassembling means.

The object manufactured may be a replica or an original of a structure disassembled by the disassembling means.

The original may be reassembled.

The method may be repeated as required.

At least some of the signals may transmit data, sound data, visual data, kinetic data, kinaesthetic data and/or scent data.

A time delay from transmission of signals by the transmission means and/or receipt by the molecular and/or sub-atomic and/or impulses of energy assembling means until the object is manufactured may be included.

A time delay from provision of signals to the transmission means and/or receipt by the molecular and/or sub-atomic and/or impulses of energy assembling means until the object is manufactured.

The transmission means may include the Internet, a local-area network (LAN), a wide-area network (WAN), any other networks, mobile telephone communication, land-line telephone communication, radio communication, satellite communication, radio-waves, micro-waves, electromagnetic impulses and any other forms of transmission and/or communication.

The processes associated with the input means and the output means may be substantially real-time relative to each other.

The transmission of the signals and/or molecular and/or sub-atomic and/or impulses of energy may be controlled from the input means and/or from the molecular and/or sub-atomic and/or impulses of energy assembling means.

The transmission of the signals may be real-time.

The transmission of the signals may be controlled from the input means and/or from the molecular and/or sub-atomic and/or impulses of energy assembling means.

The signals may include atomic and/or sub-atomic particles and/or impulses of energy.

The signals and/or atomic and/or sub-atomic particles and/or impulses of energy may be provided to the input means in electronic form.

The signals may be directly obtained by the input means from an input image and/or object and/or human and/or impulses of energy.

The system may be utilised for business means, research means and/or social means, such as conferencing, entertainment, broadcasting, education, advertising, promotions, marketing, selling, manufacturing, surgery, health-care and/or transportation

The transmission means, the input means and/or the molecular and/or sub-atomic and/or impulses of energy assembling means may be remotely operated.

The transmission means, the input means and/or the output means may be distantly spaced apart.

The remote operation may be via a telephone landline, the internet, a local-area network (LAN), a wide-area network (WAN), any other networks, mobile telephone communication, land-line telephone communication, radio communication, satellite communication, radio-waves, micro-waves, electromagnetic impulses and any other forms of transmission and/or communication.

The input means may be adapted to act as an output means and the output means may be adapted to act as an input means.

The input means may include a first adaptation means for adapting the signals and/or sub-atomic and/or atomic particles and/or impulses of energy prior to transmission by the transmission means and/or the output means include a second adaptation means for adapting the signals and/or sub-atomic and/or atomic particles and/or impulses of energy prior to being received by the assembling means.

The first adaptation means and/or the second adaptation means may include disassembling and/or assembling means.

In the specification hereinafter, the term molecular manufacturing is defined as manufacturing using molecular machinery, giving molecule-by-molecule control of products and by-products via positional chemical synthesis.

### DESCRIPTION OF AN EXAMPLE

The invention will now be described by way of an example.

The assembling system in accordance with the invention includes
(a) a transmission means, which is the internet in the present embodiment example,
(b) input means, in this example internet data/signal provider, and
(c) molecular assembling means located at a remote position from the input means.

In operation, a user located at the molecular assembling means remotely activates the input means which then transmits predetermined signals/data across the transmission means to the output means. An object manufactured by molecular manufacturing and associated with the transmitted signals/data is then manufactured at the remote position from the input means.

The input means may include molecular disassembling means adapted to take apart structures a few at a time, recording structural information at each step.

By means of the assembling means in accordance with the invention, objects may be disassembling, analysed and molecular data of the object may be transmitted over great distances and a replica and/or original of the object may take place.

The assembly system in accordance with the invention is further characterized in that it includes the following components:
(a) transmission means for transmitting signals and/or sub-atomic and/or atomic particles and/or impulses of energy;
(b) input means for providing the signals and/or sub-atomic and/or atomic particles and/or impulses of energy to be transmitted to the transmission means; and
(c) molecular and/or sub-atomic and/or impulses of energy assembling means adapted to receive the signals and/or sub-atomic and/or atomic particles and/or impulses of energy from the transmission means and capable of molecular and/or sub-atomic and/or impulses of energy manufacturing of an object defined by the sub-atomic and/or atomic particles and/or impulses of energy.

The input means includes molecular or sub-atomic and/or impulses of energy disassembling means adapted to take apart structures, and recording structural information at each step.

The molecular and/or sub-atomic and/or impulses of energy disassembling means is automated. The molecular and/or sub-atomic and/or impulses of energy assembling means is also automated.

The disassembling means is adapted to utilise nanotechnology. The molecular and/or sub-atomic and/or impulses of energy assembling means also utilise nanotechnology.

The transmission means is adapted to transport molecules and/or atoms and/or sub-atomic particles and/or impulses of energy associated with the signals.

The object manufactured by the molecular and/or sub-atomic manufacturing means is a replica or an original of a structure disassembled by the signals and/or molecular and/or sub-atomic and/or impulses of energy disassembling means. The original can thus be reassembled. The method can be repeated as required.

A time delay from transmission of signals by the transmission means and/or receipt by the molecular and/or sub-atomic and/or impulses of energy assembling means until the object is manufactured can be programmed. A time delay from provision of signals to the transmission means and/or receipt by the molecular and/or sub-atomic and/or impulses of energy assembling means until the object is manufactured can also be programmed if required. The transmission of the signals can be real-time if required.

The transmission means can include the Internet, a local-area network (LAN), a wide-area network (WAN), any other networks, mobile telephone communication, land-line telephone communication, radio communication, satellite communication, radio-waves, micro-waves, electromagnetic impulses and any other forms of transmission and/or communication.

The signals can include atomic and/or sub-atomic particles and/or impulses of energy. The signals and/or atomic and/or sub-atomic particles and/or impulses of energy can be provided to the input means in electronic form. The signals can be directly obtained by the input means from an input image and/or object and/or human and/or impulses of energy. At least some of the signals can transmit data.

The system can thus be utilised for business means, such as entertainment, broadcasting, education, advertising; promotions, marketing, selling and/or transportation.

The transmission of the signals can be controlled from the input means and/or from the molecular and/or sub-atomic and/or impulses of energy assembling means. The transmission means, the input means and/or the molecular and/or sub-atomic and/or impulses of energy assembling means can be remotely operated. The transmission means, the input means and/or the molecular and/or sub-atomic and/or impulses of energy assembling means are adapted to be located far apart. The remote operation can be via a telephone landline, the internet, a local-area network (LAN), a wide-area network (WAN), any other networks, mobile telephone communication, land-line telephone communication, radio communication, satellite communication, radio-waves, micro-waves, electromagnetic impulses and any other forms of transmission and/or communication.

1-33. (canceled)

34. An assembling system, which includes
(a) at least one transmission means for transmitting at least one element selected from the group comprising signals, sub-atomic particles, atomic particles and impulses of energy;
(b) at least one input means for providing at least one element selected from the group comprising signals, sub-atomic particles, atomic particles and impulses of energy to be transmitted to the transmission means; and
(c) at least one output means having at least one assembling means selected from the group comprising molecular, sub-atomic and impulses of energy assembling means adapted to receive the elements from the transmission means and capable of manufacturing of at least one object defined by the elements.

35. An assembling system as claimed in claim 34, in which the input means includes at least one disassembling means selected from the group comprising molecular, sub-atomic and impulses of energy disassembling means adapted to take apart structures, and recording structural information at each step.

36. An assembling system as claimed in claim 35, in which the disassembling means is automated.

37. An assembling system as claimed in claim 34, in which the assembling means is automated.

38. An assembling system as claimed in claim 34, in which the object is an object selected from the group comprising a three-dimensional object, a four-dimensional object and a hologram.

39. An assembling system as claimed in claim 34, in which the assembling means utilizes nanotechnology.

40. An assembling system as claimed in claim 34, in which the assembling means utilizes thermal imaging.

41. An assembling system as claimed in claim 35, in which the disassembling means utilizes nanotechnology.

42. An assembling system as claimed in claim 35, in which the disassembling means utilizes thermal imaging.

43. An assembling system as claimed in claim 34, in which the object is located, in relation to the input means, in a different location selected from the group comprising time periods, parallel worlds and time quadrants.

44. An assembling system as claimed in claim 34, in which the transmission means is adapted to transport in association with signals at least one element selected from the group comprising molecules, atoms, sub-atomic particles and impulses of energy.

45. An assembling system as claimed in claim 35, in which the object manufactured by the assembling means is selected from the group comprising a replica and an original of a structure disassembled by the disassembling means.

46. An assembling system as claimed in claim 45, in which the object reassembled is an original object.

47. An assembling system as claimed in claim 34, in which the manufacturing of the object is repeated as required.

48. An assembling system as claimed in claim 34, in which the elements are signals which transmit at least one component selected from the group comprising data, sound data, visual data, kinetic data, kinaesthetic data and scent data.

49. An assembling system as claimed in claim 34, which includes a time delay from transmission of the elements by the transmission means and receipt by the assembling means.

50. An assembling system as claimed in claim 34, which includes a time delay from transmission of the elements by the transmission means and manufacturing of the object.

51. An assembling system as claimed in claim 34, which includes a time delay from provision of the elements to the transmission means and receipt by the assembling means.

52. An assembling system as claimed in claim 34, which includes a time delay from provision of the elements to the transmission means and manufacturing of the object.

53. An assembling system as claimed in claim 34, in which the transmission means include at least one component selected from the group consisting of the Internet, a local-area network (LAN), a wide-area network (WAN), a network, mobile telephone communication, land-line telephone communication, radio communication, satellite communication, radio-waves, micro-waves, electromagnetic impulses, electronic transmission means and communication means.

54. An assembling system as claimed in claim 34, in which the processes associated with the input means and the output means are substantially real-time relative to each other.

55. An assembling system as claimed in claim 34, in which the transmission of the elements is controlled from at least one selected from the group comprising the input means and the assembling means.

56. An assembling system as claimed in claim 34, in which the elements are signals which include at least one element selected from the group comprising atomic particles, sub-atomic particles and impulses of energy.

57. An assembling system as claimed in claim 34, in which the elements are provided to the input means in electronic form.

58. An assembling system as claimed in claim 34, in which the elements are directly obtained by the input means from at least one object selected from the group comprising an image, a physical object, a human being and impulses of energy.

59. An assembling system as claimed in claim 34, which is utilized for at least one function selected from the group comprising a business function, a research function, a social function, conferencing, entertainment, broadcasting, education, advertising, promotions, marketing, selling, manufacturing, surgery, health-care and transportation.

60. An assembling system as claimed in claim 34, in which the transmission means is remotely operated.

61. An assembling system as claimed in claim 34, in which the assembling means is remotely operated.

62. An assembling system as claimed in claim 34, in which the input means and the output means spaced distantly apart.

63. An assembling system as claimed in claim 60, in which the remote operation is via at least one selected from the group comprising a telephone landline, the internet, a local-area network (LAN), a wide-area network (WAN), a network, mobile telephone communication, land-line telephone communication, radio communication, satellite communication, radio-waves, micro-waves, electromagnetic impulses, electronic transmission means and communication means.

64. An assembling system as claimed in claim 61, in which the remote operation is via at least one selected from the group comprising a telephone landline, the internet, a local-area network (LAN), a wide-area network (WAN), a network, mobile telephone communication, land-line telephone communication, radio communication, satellite communication, radio-waves, micro-waves, electromagnetic impulses, electronic transmission means and communication means.

65. An assembling system as claimed in claim 34, in which the input means is adapted to act as an output means and the output means is adapted to act as an input means.

66. An assembling system as claimed in claim 34, in which the input means include an input adaptation means for adapting the elements prior to transmission by the transmission means.

67. An assembling system as claimed in claim 35, in which the output means include an output adaptation means for adapting the elements prior to being received by the assembling means.

68. An assembling system as claimed in claim 66, in which the input adaptation means includes disassembling and assembling means.

69. An assembling system as claimed in claim 67, in which the output adaptation means includes disassembling and assembling means.

70. A method for manufacturing an object, which includes the steps
(a) of providing at least one element selected from the group comprising signals, sub-atomic particles, atomic particles and impulses of energy to be transmitted to at least one transmission means;
(b) of transmitting the elements transmitted to the transmission means to at least one output means having at least one assembling means selected from the group comprising molecular, sub-atomic and impulses of energy assembling means; and
(c) of manufacturing an object defined by the elements received by the assembling means from the transmission means.

71. A method as claimed in claim 70, in which the input means includes at least one disassembling means selected from the group comprising a molecular, sub-atomic and impulses of energy disassembling means adapted to take apart structures, and recording structural information at each step.

72. A method as claimed in claim 70, in which the assembling means utilizes nanotechnology.

73. A method as claimed in claim 70, in which the assembling means utilizes thermal imaging.

74. A method as claimed in claim 71, in which the disassembling means utilizes nanotechnology.

75. A method as claimed in claim 71, in which the disassembling means utilizes thermal imaging.
